(19) United States
(12) Patent Application Publication
(10) Pub. No.: US 2008/0047963 A1
(43) Pub. Date: Feb. 28, 2008

(54) BOSS SYSTEM

(75) Inventors: Brian A. Wilson, Folsom, CA (US); W. Donald Humphrey, Lincoln, NE (US); Peter J. Williams, Cameron Park, CA (US); Richard L. Grover, Whittier, CA (US); Steven J. Zitek, Brea, CA (US)

Correspondence Address: PEACOCK MYERS, P.C., 201 THIRD STREET, N.W., SUITE 1340, ALBUQUERQUE, NM, 87102, US

(73) Assignee: Wilson Composite Technologies, Folsom, CA (US)

(21) Appl. No.: 11/466,362

(22) Filed: Aug. 22, 2006

(51) Int. Cl. F17C 13/06

(52) U.S. Cl. 220/582

(57) ABSTRACT

The present invention relates to a lightweight boss system for use on a tank or pressure vessel. The boss system is preferably made of a composite or resin transfer molded (RTM) material. It is particularly useful for composite tanks, such as filament-wound composite tanks.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. FA9453-03-C-0212 awarded by the Air Force Research Laboratory.

### BACKGROUND OF THE INVENTION

1. Field of the Invention (Technical Field)

The present invention relates to a boss for storage tanks. The boss is lightweight, preferably comprises a composite material, uses a variety of sealing technology methods, is effective at low cryogenic pressures and temperature conditions (e.g. for liquid hydrogen and liquid helium) and is adjustable for standardized use for different lengths, widths, and types of tanks and for various fluids and their various properties.

2. Description of Related Art

Note that the following discussion refers to a number of publications by author(s) and year of publication, and that due to recent publication dates certain publications are not to be considered as prior art vis-à-vis the present invention. Discussion of such publications herein is given for more complete background and is not to be construed as an admission that such publications are prior art for patentability determination purposes.

The use of composite materials, and in particular organic composites, in military and commercial aircraft, rotary wing structures and U.S. Navy, Army, and Air Force missiles has been common practice since the early 1960's. These organic matrix composite materials have utilized structural fibers and organic polymer matrices to provide lightweight, high strength, critical structures. These materials are used in tanks, cases and vessels.

Tanks, cases or vessels usually have an access port for the connection of components. The access port usually has a boss assembly for this attachment purpose. There are usually metallic boss systems with metallic attachment rings and closures on the tank. These traditional metal boss closure systems contribute up to 90% of a linerless tank's weight. Such tanks may have a liner or can be linerless.

A typical example of a prior art boss system is described in U.S. Pat. No. 5,429,845 to Newhouse et al., entitled “Boss for a Filament Wound Pressure Vessel”, issued Jul. 4, 1995. This discloses a metallic boss disposed in a polar opening in a pressure vessel which has a filament wound outer shell and a non-metallic internal liner.

There have been attempts to develop composite bosses that in the prior art use pressure-assisted seals. However, these bosses are potentially ineffective at low cryogenic pressures and temperature conditions typical for liquid hydrogen and liquid helium.

Thus, there is a need for composite bosses to decrease weight, while also providing better sealing to increase efficacy at cryogenic temperatures and pressures. In the present invention, composite boss configurations eliminate heavyweight bosses or adapters used with motor cases, tanks, and pressure vessels in order to minimize weight and total part count.

### BRIEF SUMMARY OF THE INVENTION

The present invention relates to a boss system, particularly useful for composite tanks. The boss system comprises a closure plate, a gasket, and a fastener inserted into an end of the tank.

The closure plate preferably comprises a composite material. The closure plate may be flat or may be inverted at an end of the tank. The closure plate may comprise any number of fasteners, but preferably at least 20 fasteners.

The gasket preferably comprises a compression gasket. The gasket may be external to the tank or internal to the tank. The gasket preferably has an installed compression of at least 3000 psi. The gasket may comprise an expandable material. There may be additional gaskets comprising a crush seal. In an alternative embodiment, the gasket comprises a spring energized face seal. This face seal may be disposed between the closure plate and an end of the tank. Or, the face seal may be disposed in a notch of the closure plate. An additional gasket may be disposed at an end of the fastener.

The fastener may further comprise an insert. This insert may comprise internal threads, external threads, or both.

The boss system may further comprise a ring fitting. The ring fitting comprises internal seal plies disposed in a helical layered configuration. The helical layers are in differing orientations.

The fastener may comprise a head disposed above the closure plate and/or, a head disposed inside the tank and/or a countersink. The end of the fastener may be covered by an internal seal ply and/or a bonded fitting ring disposed inside the tank.

A primary object of the present invention is to provide a lightweight boss system which provides adequate sealing of a tank, and more particularly of a composite tank.

Another object of the present invention is to provide a boss system comprising components that will not react with tank contents.

Yet another object of the present invention is to provide a system which is flexible and can meet various service requirements.

A primary advantage of the present invention is that it is lightweight.

Another advantage of the present invention is that it preferably comprises inert materials.

Yet another advantage of the boss system is it ensures a seal and no leakage in a linerless tank.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. As shown therein:

FIG. 1 is a cross-sectional view of a boss system of the present invention with an external compression gasket with a bolt seal;

FIG. 2 is a cross-sectional view of an alternative boss system with an internal compression gasket with internal seal plies;

FIG. 3 is a cross-sectional view of an alternative boss system with an internal compression gasket with expanded polytetrafluoroethylene (PTFE) bolt seals;

FIG. 4 is a cross-sectional view of an alternative boss system with an internal compression gasket with expanded sealed inserts;

FIG. 5 is a cross-sectional view of an alternative boss system with a high-performance spring energized face seal;

FIG. 6 is a cross-sectional view of an alternative boss system with a high-performance spring energized shaft seal;

FIG. 7 is a cross-sectional view of an alternative boss system with a bonded fitting with a high-performance spring energized shaft seal;

FIG. 8 is a cross-sectional view of a tank with a dome extension version of a boss system;

FIG. 9 is a cross-sectional view of the dome extension of FIG. 8 showing a layered structure;

FIG. 10 is a top view of a closure plate showing multiple fastener holes; and

FIG. 11 shows a cross-sectional view of an alternate embodiment of a boss system with threaded inserts.

### DETAILED DESCRIPTION OF THE INVENTION

The present invention is directed to boss systems which are lighter, stronger, smaller, more reliable, and less expensive. Composite materials, preferably used in the present invention, provide an improvement to the performance characteristics associated with fatigue strength, structural weights, and operational lifetimes. The boss systems of the present invention provide leak-free operation and significant weight reduction over a full range of operating temperatures and other parameters. The composite boss systems of the present invention are particularly useful in larger pressure vessel and tank systems.

The present invention preferably comprises a boss closure system for tanks, cases or pressure vessels. The boss system is particularly useful for linerless composite cryogenic storage pressure vessels. The boss system is easily removable and installable, lightweight, and effective at low temperatures and at various cryogenic pressures. The boss system is an effective sealing system for linerless, non-metal tanks holding liquid hydrogen, liquid oxygen, hydrogen peroxide, and inert materials including but not limited to liquid nitrogen and liquid helium. However, the boss systems of the present invention can be used for any type of tank, case or pressure vessel, including but not limited to composite or metal tanks, and tanks with or without liners. The term “tank” is used throughout the specification and claims and is intended to include tanks, cases, vessels, or any other storage device which has an opening and requires a sealed boss closure system.

The boss system of the present invention generally comprises a lightweight cover, a gasket system that keeps fasteners separated from the contents stored in the interior of the tank, a cover plate and secure connections between the cover plate and tank. Although the tank may be linerless, the boss system ensures a seal and no leakage. In the preferred embodiments, the boss system comprises seals to prevent liquid within the tank from touching fasteners or seals used in the boss system. In the preferred embodiments, the closure plate is preferably made of composite material, but may be made of metal or other materials. Likewise, the tank is preferably made of a composite material, including but not limited to a filament-wound composite.

The drawings show several preferred and alternate embodiments of the boss system of the present invention. These embodiments are discussed below.

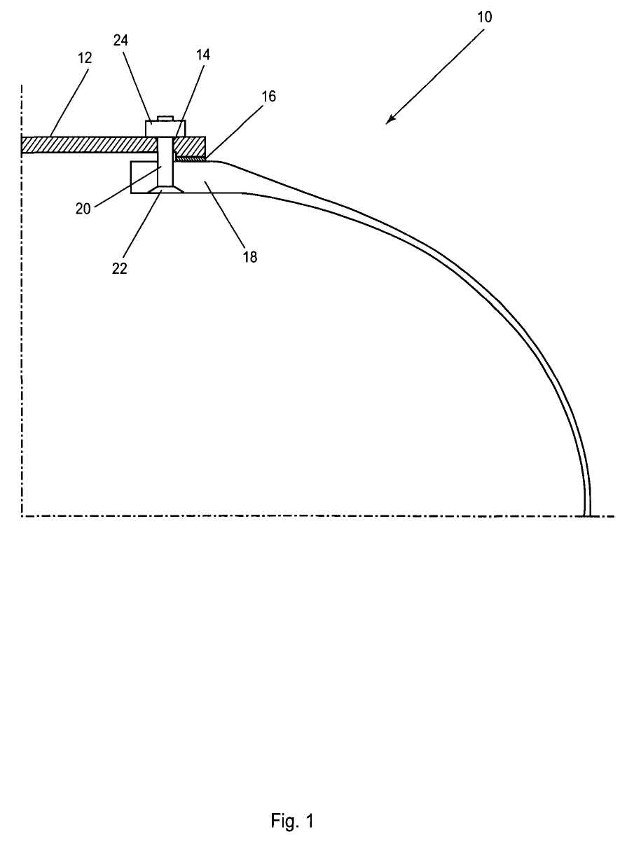

FIG. 1 is a cross-sectional view of boss system 10 on tank 18 comprising external compression gasket 16, crush seal 14, and fastener 20 connecting closure plate 12 to tank 18. Tank 18 is preferably reinforced at the area of closure plate 12. External gasket 16 is disposed between closure plate 12 and tank 18 to seal any potential leak path within the structure, including but not limited to any space between fastener 20 and the hole within which it is installed. Gasket 16 is external to tank 18 and fastener 20 and thus does not come into contact with the contents of tank 18. Gasket 16 is preferably expandable, using any expandable material, including but not limited to polytetrafluoroethylene (PTFE), such as the PTFE commonly known as Gore-Tex®, manufactured by W. L. Gore & Associates, Inc. Gasket 16 preferably has high bolt preload, is installed with compression, preferably at least 3000 psi. FIG. 1 shows fastener or bolt 20 inserted in composite tank 18 with protruding head 24 disposed above closure plate 12. The same fastener hole that accommodates bolt 20 also has countersink 22. Additionally, composite boss system 10 comprises seal 14 disposed between closure plate 12 and protruding head 24. Seal 14 preferably comprises a crush washer or a crush seal.

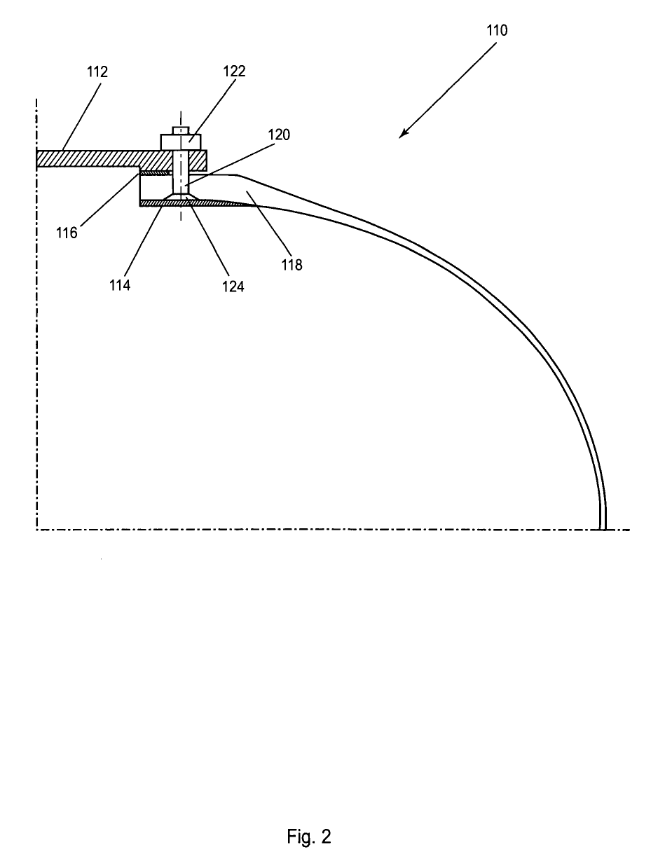

FIG. 2 is a cross-sectional view of alternative boss system 110 on tank 118 comprising internal compression gasket 116 and internal seal plies 114 to seal any potential leak path within tank 118. Fastener 120 (e.g. a bolt) connects cover plate 112 to tank 118. External compression gasket 116 is installed in compression, preferably at least with 3000 psi compression and high bolt preload. Compression gasket 116 is preferably an expansion material, including but not limited to expanded polytetrafluoroethylene (PFTE). Fastener 122 preferably comprises a bolt with a protruding head 122, inserted in tank 118. Fastener 120 preferably comprises countersink 124 inserted to provide enhanced connection capability for boss system 110. Additionally, seal plies 114 are preferably installed after stud holes are drilled and fastener 120 is installed. Seal plies 114 provide enhanced sealing of boss system 110 on tank 118. Gasket 116 and seal plies 114 come into contact with the contents of tank 118, and are thus preferably made of materials which are inert or do not react with the contents of tank 118. This is also applicable to the other embodiments described and shown herein in which the components are exposed to fluids or contents of the tanks.

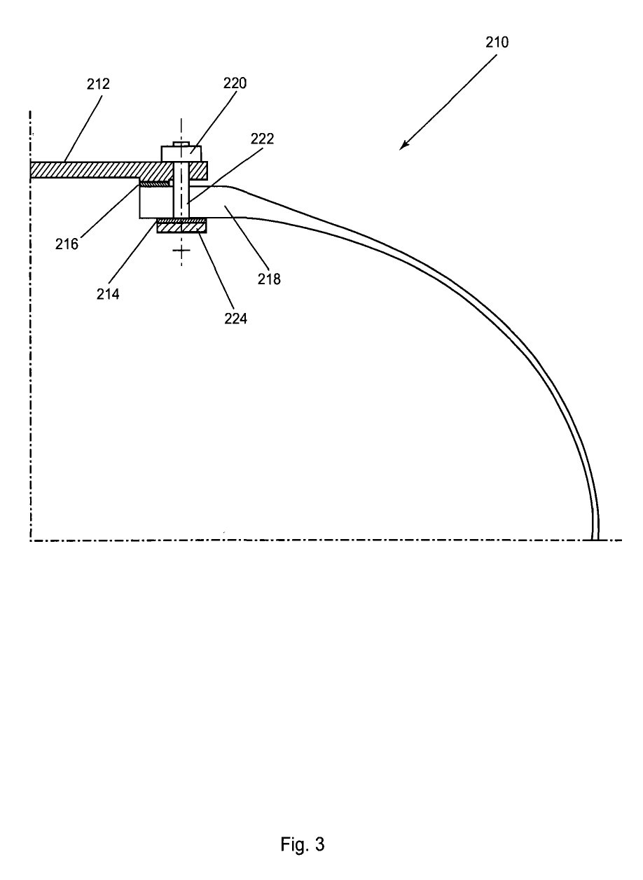

FIG. 3 is a cross-sectional view of alternate boss system 210 on tank 218. Boss system 210 comprises internal compression gasket 216, internal fastener seal gasket 214, and fastener 222 connecting cover plate 212 to tank 218. Compression gasket 216 is preferably an expansion material, including but not limited to expanded polytetrafluoroethylene (PFTE). Internal compression gasket 216 is installed in compression, preferably at least with 3000 psi compression and high bolt preload. Fastener 222 preferably comprises a bolt comprising outer protruding head 220. In this embodiment, fastener 222 comprises internal head 224 which protrudes into tank 218. Internal fastener seal gasket 214 provides additional sealing around internal head 224. The surface area of internal gasket 216 and the cumulative areas of all fastener seal gaskets 214 are preferably equal so that they are equally loaded in compression as fastener 222 is tightened. Fastener 222 is preferably tightened incrementally to avoid overload of gaskets 216 and 214.

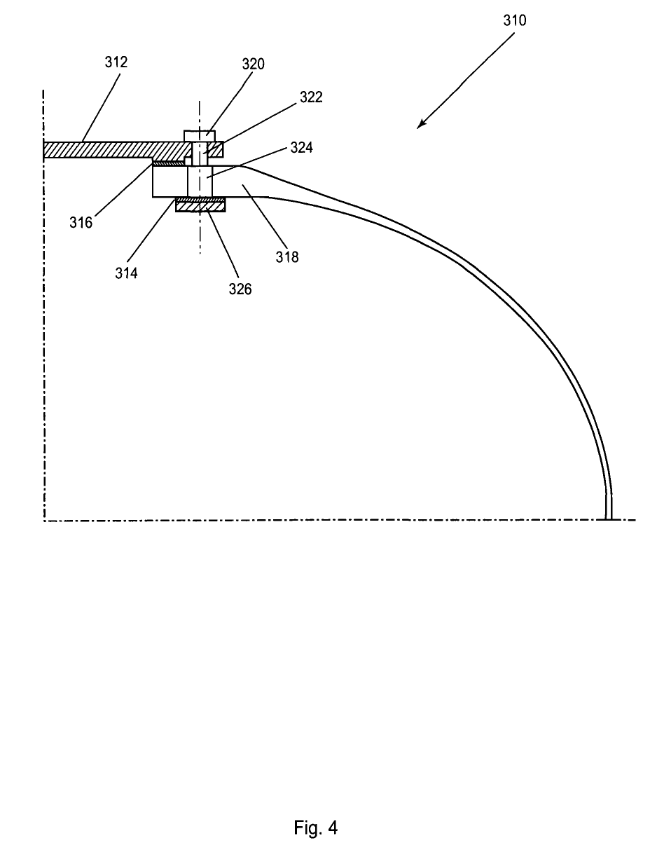

FIG. 4 is a cross-sectional view of boss system 310 on tank 318. Boss system 310 comprises internal compression gasket 316, internal compression fastener gasket 314, and fastener 322. Gaskets 314 and 316 preferably comprise expanded PTFE seal material. Fastener 322 secures closure plate 312 to tank 318. Fastener 322 preferably comprises a bolt comprising outer protruding head 320 and internal head 326. Fastener 322 preferably inserts in cylindrical stud hole which optionally comprises insert 324 comprising internal threads. Insert 324 engages and secures fastener 322, engaging and securing composite boss 310 during the assembly process. Gaskets 314 and 316 are preferably installed with 3000 psi compression, a large bolt preload, and a head on the backside of gaskets 314 and 316. The total area of bolt seal gaskets 316 and 314 are preferably equal in area so that they are equally loaded in compression as fastener 322 is tightened. Bolt 322 is preferably tightened incrementally to avoid overload of bolt compression seal gaskets 316 and 314.

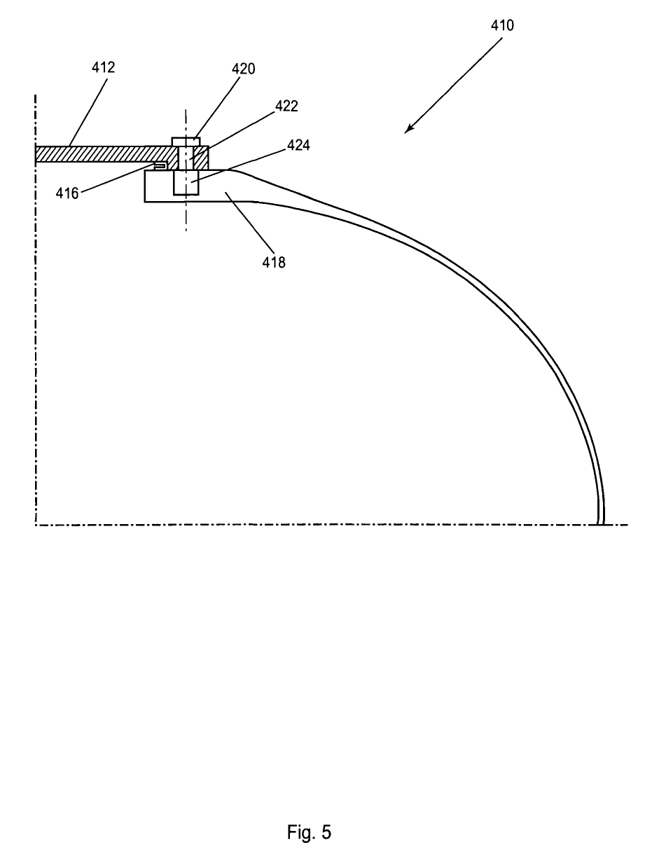

FIG. 5 is a cross-sectional view of boss system 410 on tank 418, preferably comprising seal 416, fastener 422, and insert 424. Fastener 422 preferably comprises a bolt comprising outer protruding head 420. Insert 424 may comprise internal and/or external threads and enhances attachment of closure plate 412 to tank 418. Seal 416 preferably comprises a high-performance spring energized face seal commonly known as an Omni-Seal®. This seal is preferably made of any expansion material, including but not limited to high-performance spring energized PTFE and stainless steel. Face seal 416 is disposed between the top of tank 418 and the bottom of closure plate 412. Bolt 422 connects closure plate 412 to tank 418 and is moderately preloaded.

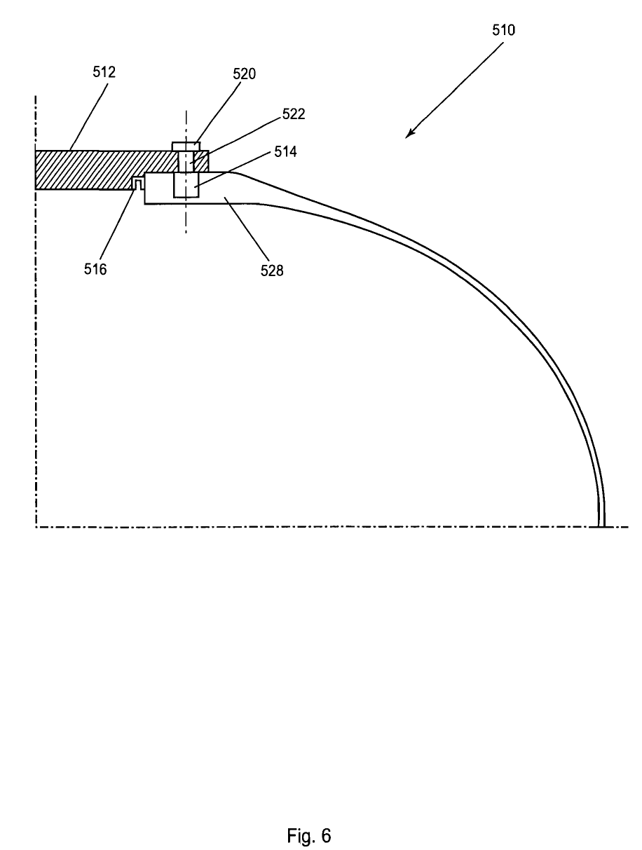

FIG. 6 is a cross-sectional view of boss system 510 on tank 518 preferably comprising shaft face seal 516, fastener 522 connecting closure plate 512 to tank 518, and insert 514. Insert 514 may comprise internal and/or external threads and enhances attachment of closure plate 512 to tank 518. Fastener 522 preferably comprises a bolt comprising outer protruding head 520. Shaft seal 516 preferably comprises an expansion material, including but not limited to high-performance spring energized PTFE or stainless steel. Shaft seal 516 is disposed in a notch in closure plate 512 at the end of tank 518. Boss system 510 is particularly useful for low pressure applications where insert shear stress is not excessive.

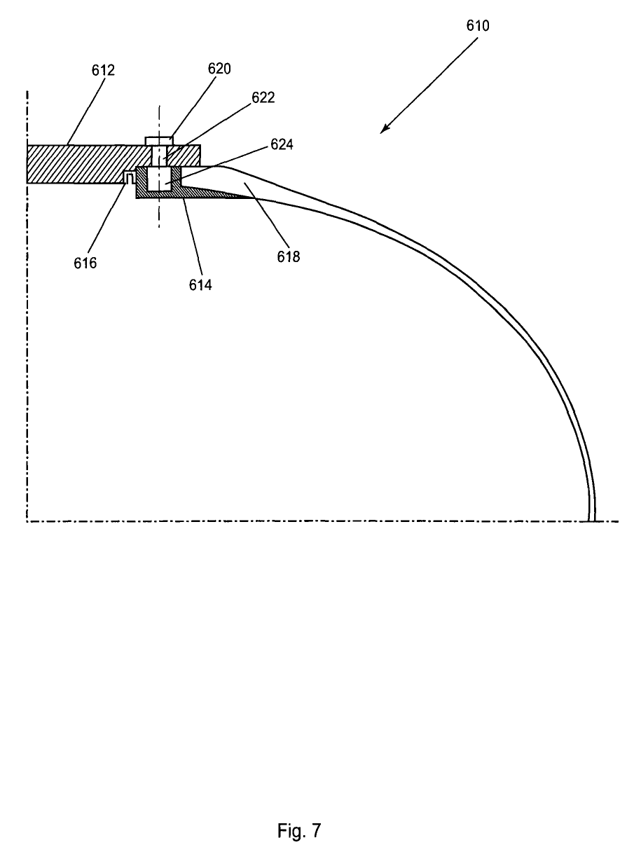

FIG. 7 is a cross-sectional view of boss system 610 on tank 618 comprising fastener 622 connecting closure plate 612 to tank 618. Fastener 622 preferably comprises a bolt comprising outer protruding head 620. Internal fitting ring 614 is preferably bonded and comprises internal and/or external threads. Shaft seal 616 preferably comprises an expansion material, including but not limited to high-performance spring energized PTFE or stainless steel. Shaft seal 616 is disposed in a notch between closure plate 612 and internal fitting ring 614 to provide enhanced seal capability. Bonded fitting ring 614, with compatible adhesive, is precisely shaped and preferably comprises a 3D composite. The 3D composite preferably comprises fiber filled plastic and is preferably resin transfer molded (RTM) and alternately injection molded. Bonded composite fitting ring 614 contributes to an enhanced seal when the bond with tank 618 is effective. Composite boss system 610 is particularly useful for low pressure applications where insert shear stress is not excessive.

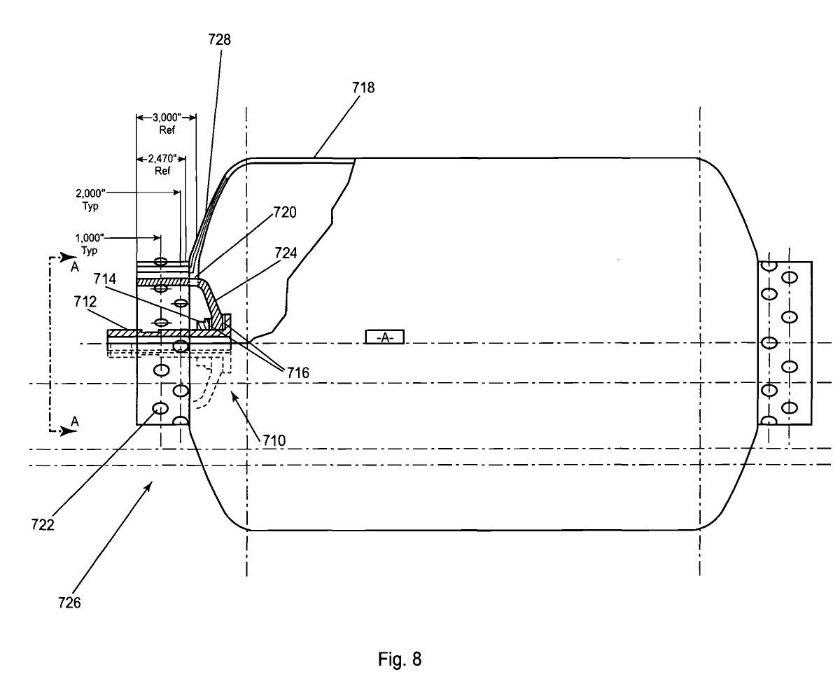

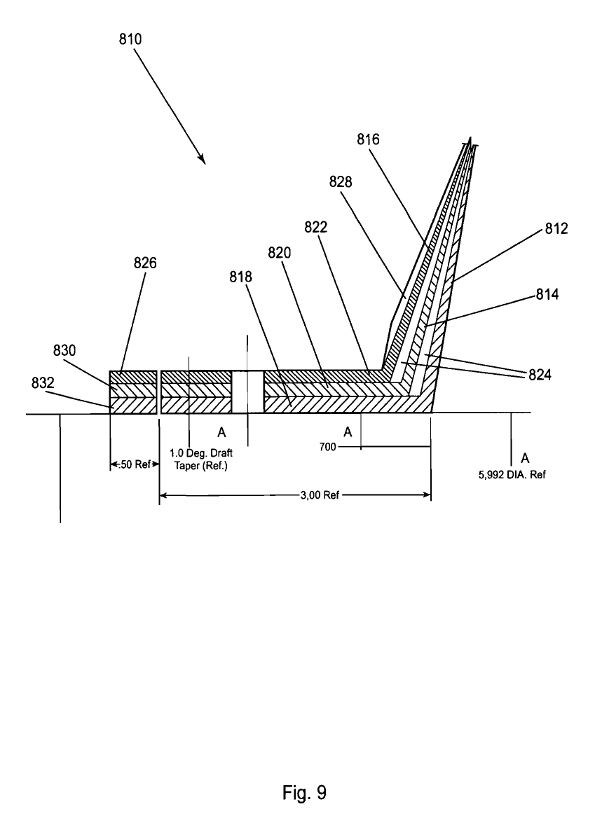

FIGS. 8 and 9 show views of dome extension 726 and boss 710 on tank 718. End closure 724 is trimmed to fit flush with an end surface of dome extension 726. End closure 724 is preferably made of a composite material, including but not limited to a filament-wound composite material or a resin transfer molded (RTM) material. Connection fitting 712 (which may be metal, composite or other material) preferably provides access to the interior of tank 718. Locking nut 714 preferably secures fitting 712 in place. Compression washers 716 provide sealing against end closure 724. Compression seal 720 preferably seats in O-ring groove, preventing leakage through the interface between pressure vessel tank 718 and dome 728. Bolt fasteners (e.g. bolts, lock washers, and nuts) in drilled holes 722 preferably secure cup-shaped end closure 724 into dome 728 of tank 718.

FIG. 9 shows dome extension ring 810 preferably comprising a layered ply structure disposed on top of filament wound dome 812. The wall structure of dome extension ring 810 comprises helical layers 812, 814, and 816. Helical layers 812, 814 and 816 preferably comprise filaments wound on pressure vessel dome 726 as shown in FIG. 8. Helical layer 812 is typically a continuation of dome 726 and composite tank wall 718 as shown in FIG. 8. Final layer 828 is a closure layer, applied as the final structure layer and comprises part of dome 726 and composite tank wall 718 as shown in FIG. 8. Ply layer 818 is disposed adjacent to ply layer 820, which is disposed adjacent to ply layer 822. Ply layers 818, 820, and 822 are preferably disposed in differing orientation in order to provide the necessary strength for the structure. Ply layers 818, 820, and 822 preferably comprise tape or alternately comprise filament wound extensions of layers 718, 814, and 816. Alternately, ply layers 818, 820, and 822 comprise fabric or other materials. Excess material 826, 830, and 832 is preferably machined off the end of dome extension ring fitting 810 to provide a flat reference surface. Filler 824 between plies 818, 820 and 822 preferably comprises a paste comprising resin and chopped fiber and alternately comprises cut and laid-up resin-impregnated layers of tape or fabric. Filler 824 is disposed at the connection between dome extension ring fitting 810 and dome 726.

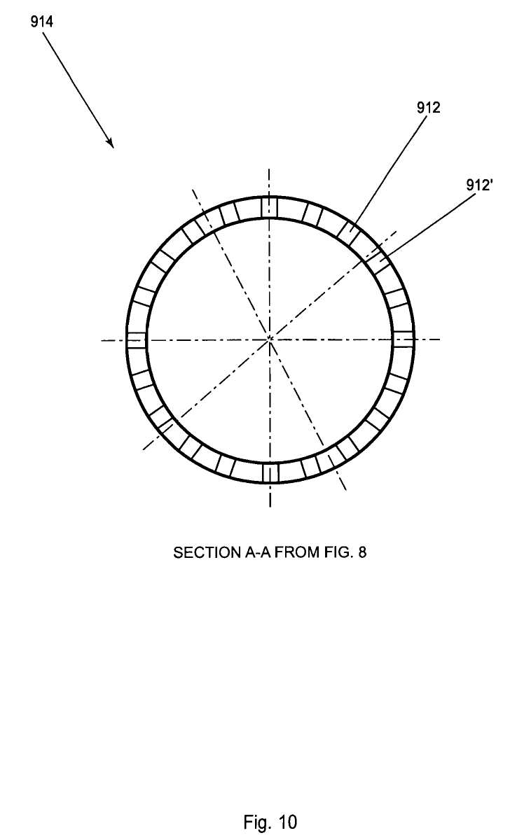

FIG. 10 is a cross-sectional view of closure plate 914 comprising multiple fastener holes 912. The preferred closure plates described herein are fastened by multiple fasteners, preferably between 8 and 24 fasteners, and most preferable 20 fasteners as shown by the 20 fastener holes 912 (only two labeled) shown in FIG. 10. This permits closure cup 724 as shown in FIG. 8 to be maintained in a right-circular position relative to layer 818 as shown in FIG. 9 and prevents leakage.

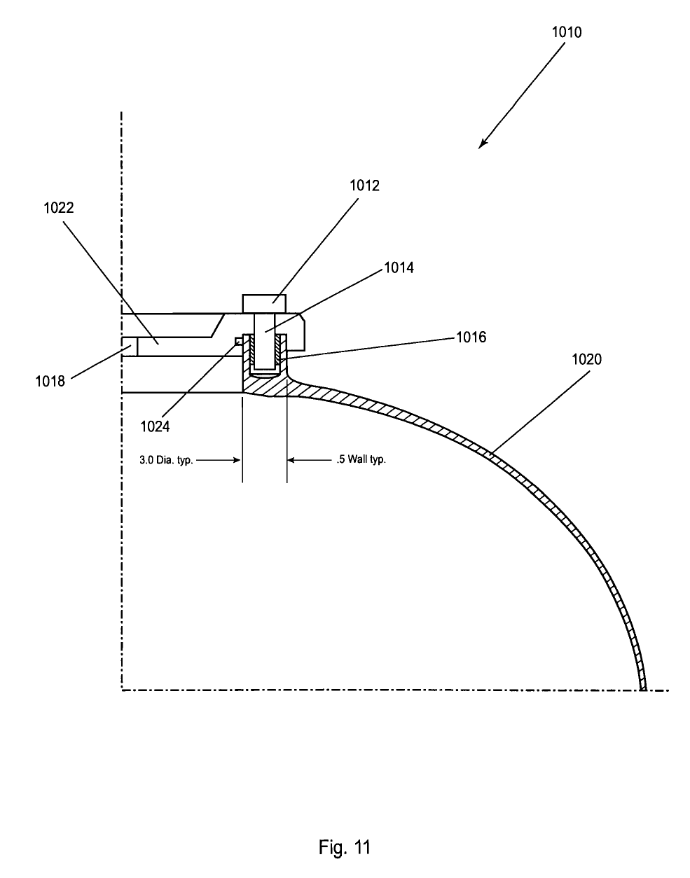

FIG. 11 is a cross-sectional view of boss system 1010 on tank 1020. Boss system 1010 comprises fastener 1014, insert 1016 and seal 1024. Fastener 1014 preferably comprises a cap screw comprising outer protruding head 1012. Fastener 1014 connects closure plate 1022 to tank 1020. Threaded insert 1016 is disposed between cap screw 1012 and tank 1020, enhancing connection. Seal 1024 is disposed between a notch in closure plate 1022 and tank 1020. Seal 1024 preferably comprises a high-performance spring energized PTFE shaft face seal and alternately a high compression seal. Closure plate 1022 comprises port opening 1018. Port openings are also contemplated in the other embodiments described herein.

Tank, closure plate, end closure, dome extension ring fitting, and seal plies are preferably comprised of composite material in all embodiments, including but not limited to filament-wound composite, tape, fabric, and resin transfer molded (RTM) construction. Tank, closure plate, and seal plies are optionally comprised of other materials. Fasteners may be metal, composite or other materials.

### EXAMPLES

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

### Example 1

A boss system as shown in FIG. 1 was constructed. The closure plate was made of a composite material. An external polytetrafluoroethylene gasket was placed between the composite cover plate and the tank dome. A bolt was countersunk and installed. The gasket was installed under 3000 psi compression, high bolt preload, and a head on the backside of the gasket. A crush washer seal was installed between the cover plate and tank.

### Example 2

A boss system as shown in FIG. 2 was constructed. An internal polytetrafluoroethylene compression gasket was installed with 3000 psi compression and a high bolt preload. Internal seal plies were installed after the stud holes were drilled and the fastener was installed and sealed the leak path within the tank. A bolt was installed and connected the composite cover plate to the composite filament-wound tank.

### Example 3

A boss system as shown in FIG. 3 was constructed. A polytetrafluoroethylene internal compression gasket was installed at 3000 psi compression and a high bolt preload. A bolt was installed to connect the composite cover plate to the filament-wound composite tank, and with an internal head protruding into the interior of the tank. An internal fastener seal gasket was installed between the interior of the tank and the protruding head of the bolt and loaded in compression as the bolt was incrementally tightened.

### Example 4

A boss system as shown in FIG. 4 was constructed. An expanded PTFE internal compression gasket was installed on the cover plate and the tank surface for later installation of the cover plate, with 3000 psi compression and a large bolt preload. Another internal compression gasket was installed between the lower surface of the tank and the bolt's protruding head, with 3000 psi compression and a large bolt preload. A bolt with a head protruding into the interior of the tank was inserted into a stud hole drilled into an internally threaded insert within the composite tank wall and tightened incrementally to avoid overload of the bolt seal gaskets.

### Example 5

A boss system as shown in FIG. 5 was constructed. A bolt was moderately preloaded and then screwed into an externally and internally threaded insert and connected the composite cover plate to the composite tank. Both the bolt and insert were not in contact with the interior of the tank. A high-performance spring energized PTFE face seal was installed between the tank and the cover plate.

### Example 6

A boss system as shown in FIG. 6 was constructed. A bolt was installed into an internally and externally threaded insert and connected the composite closure plate to the composite filament-wound tank. The insert was subjected to low pressure and low shear stress. The bolt and insert were not in contact with the contents of the tank.

### Example 7

A boss system as shown in FIG. 7 was constructed. A bolt was installed and connected the composite closure plate to the tank using an internally and externally threaded internal fitting ring. The fitting ring was made of layers of materials bonded in layers, was made of fiber-filled plastic and was injection molded.

### Example 8

A boss system as shown in FIGS. 8 and 9 was constructed. An end closure was trimmed to fit flush with a dome extension of the boss system and installed on a composite tank. A metallic connection fitting was installed and provided access to the interior of the tank. A locking nut was installed and secured the fitting in place. Compression washers were installed in an O-ring groove between the end closure and dome extension and prevented leakage through the interface between the pressure vessel tank and the dome insert. Bolt fasteners, lock washers, and nuts were installed and secured the cup-shaped end closure to the dome insert of the tank.

A dome extension ring as shown in FIG. 9 was constructed. The ring was made by layering plies in a helical configuration. The helical layers were made of filaments wound on a pressure vessel dome such as that seen in FIG. 8. The ply layers were made of tape and laid down in differing orientations in order to provide necessary strength for the structure. Ply layers made of fabric were also laid down in differing orientations. Any excess material was machined off the end of the dome extension ring fitting and created a flat reference surface. The space between the ply layers and the space at the root of the connection between the dome extension ring fitting and the dome were filled with a paste made of resin and chopped fiber. A layer of paste 1/10^{th} of an inch thick at its base and minimally ½″ high was used. A closure layer was applied as a final filament wound layer to the tank.

### Example 10

A boss system as shown in FIG. 11 was constructed. A cap screw was screwed into a threaded insert that was installed into the tank shell and connected the closure plate to the tank. A high-performance spring energized PTFE shaft face seal was placed between the closure plate and the tank and thus enhanced the quality of the boss system's seal. A port opening was constructed in the closure plate to provide access to the interior of the tank.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above and/or in the attachments, and of the corresponding application(s), are hereby incorporated by reference.

1. A boss system for use on a tank comprising:
a closure plate;
a gasket; and
a fastener inserted into an end of said tank.

2. The boss system of claim 1 wherein said closure plate comprises a composite material.

3. The boss system of claim 1 wherein said closure plate is flat.

4. The boss system of claim 1 wherein said closure plate is inverted at an end of said tank.

5. The boss system of claim 1 wherein said gasket comprises a compression gasket.

6. The boss system of claim 1 wherein said gasket is external to said tank.

7. The boss system of claim 1 wherein said gasket is internal to said tank.

8. The boss system of claim 1 wherein said gasket comprises an expandable material.

9. The boss system of claim 1 wherein said gasket comprises a crush seal.

10. The boss system of claim 1 wherein said gasket comprises a spring energized face seal.

11. The boss system of claim 10 wherein said face seal is disposed between said closure plate and an end of said tank.

12. The boss system of claim 10 wherein said face seal is disposed in a notch of said closure plate.

13. The boss system of claim 1 wherein said gasket is disposed between said closure plate and an end of said tank.

14. (canceled)

15. The boss system of claim 1 wherein said fastener further comprises an insert.

16. The boss system of claim 15 wherein said insert comprises internal threads.

17. The boss system of claim 15 wherein said insert comprises external threads.

18. The boss system of claim 15 wherein said insert comprises external and internal threads.

19. The boss system of claim 1 further comprising a ring fitting.

20. (canceled)

21. The boss system of claim 19 wherein said ring fitter further comprises internal seal plies are in a helical layered configuration.

22. The boss system of claim 21 wherein said helical layers are in differing orientations.

23. The boss system of claim 1 wherein said fastener comprises a head disposed above said closure plate.

24. The boss system of claim 1 wherein said fastener comprises a head disposed inside said tank.

25. The boss system of claim 1 wherein said gasket has installed compression of at least 3000 psi.

26. The boss system of claim 1 wherein said fastener further comprises a countersink.

27. (canceled)

28. The boss system of claim 1 further comprising internal seal plies inside said tank covering an end of said fastener.

29. The boss system of claim 1 further comprising a bonded fitting ring disposed inside said tank covering an end of said fastener.
